(19) United States
(12) Patent Application Publication
(10) Pub. No.: US 2025/0389377 A1
(43) Pub. Date: Dec. 25, 2025

(54) CARRIER, PREFERABLY MONITOR CARRIER, WITH CENTER OF GRAVITY ADJUSTMENT VIA ELONGATED HOLE

(71) Applicant: Mavig GmbH, Muenchen (DE)

(72) Inventors: Hendrik Thomann, Erlangen (DE); Marc Hoffstetter, Muenchen (DE)

(73) Assignee: Mavig GmbH, Muenchen (DE)

(21) Appl. No.: 19/244,142

(22) Filed: Jun. 20, 2025

(30) Foreign Application Priority Data
Jun. 19, 2024 (EP) 24183148.6

(51) Int. Cl. F16M 13/02; F16M 11/10

(52) U.S. Cl. CPC F16M 13/02; F16M 11/10; F16M 2200/041

(57) ABSTRACT

The invention relates, among other things, to a carrier for carrying an apparatus, the carrier comprising: a fastening means with two screws; a support arm positioned in a first direction relative to the fastening means, wherein the apparatus is at least indirectly attachable to the support arm, wherein the support arm comprises two elongated holes in a (first) plane, wherein the (first) plane extends perpendicular to the first direction, and wherein the two elongated holes are aligned in a same direction; at least one counterpart, wherein the two screws are adapted to connect the fastening means to the at least one counterpart through the two elongated holes.

The disclosure relates to a carrier and a method of manufacturing a carrier.

Support arm systems are used in hospitals, doctors' surgeries and similar facilities to carry, for example, medical apparatuses, and they are suspended from the ceiling or wall of the respective treatment room or operating theater via a fastening anchor. This ensures that the floor of the treatment room or operating theater is always freely accessible and, in particular, easy to clean and disinfect, so that the hygiene requirements can be met. Apparatuses such as monitors are often attached to the bottom of a support arm (by means of a suspension). The apparatus then tilts so that its center of gravity is vertically below (a pivot point of) the suspension. To change an angle of the apparatus, it is therefore necessary to change the suspension point relative to the center of gravity of the apparatus.

The document DE 100 43 895 A1 discloses a carrier for carrying at least one apparatus, in particular for carrying screen display devices and other medical devices. The carrier has a support arm, to which the apparatus is attachable at least indirectly, and a fastening means which engages in a connecting portion of the support arm for suspending the carrier. The point of engagement can be changed in order to displace the center of gravity of the loaded support arm at a predetermined inclination of the support arm at least approximately below the suspension point at which the carrier is suspended by means of the fastening means.

Known carriers are complex to construct and modify, and they are also expensive. Known carriers also require a lot of space.

The aforementioned disadvantages are at least partially avoided by features of the independent claims. Dependent claims show preferred embodiments of the invention.

In detail, the present disclosure comprises a carrier for carrying an apparatus, the carrier comprising: a fastening means with two screws; a device carrier positioned in a first direction relative to the fastening means, wherein the apparatus is at least indirectly attachable to the device carrier, wherein the device carrier comprises two elongated holes in a (first) plane, wherein the (first) plane extends perpendicular to the first direction, and wherein the two elongated holes are aligned in a same direction; at least one counterpart, wherein the two screws are adapted to connect the fastening means to the at least one counterpart through the two elongated holes.

The two (or more) screws of the fastening means may be passed through the elongated holes (preferably one screw per elongated hole) and then screwed into the counterpart. The elongated recess in the elongated holes allows the device carrier to be displaced relative to the fastening means. Once a desired relative position has been reached, the screws may be tightened to prevent further displacement. Such an adjustment of the relative position is easy to implement-during the initial assembly as well as during adjustment (for example, when the fastened apparatus is replaced). Such a carrier is also inexpensive and space-saving.

The fastening means may be indirectly connected to a wall or ceiling (for example via a cardanic suspension, a support arm and/or the like). The fastening means has two holes through which the two screws may be passed. By displacing the fastening means relative to the device carrier (by means of the screws in the elongated holes), the center of gravity of the fastened apparatus may be shifted relative to the suspension. This allows an angle of the fastened apparatus to be changed. The screws preferably extend in the first direction.

The apparatus may be a screen/monitor, tool, tray (storage), lamp, other medical device or the like.

The device carrier preferably holds the apparatus directly and is attached directly to the apparatus (if attached). In the mounted state, the first direction corresponds to a vertical downward direction (perpendicular). The first plane is correspondingly horizontal. The apparatus may be fastened to the device carrier using additional fastening elements (screws, clamps, etc.). The elongated holes may be milled, cut, left free during casting or otherwise produced in the device carrier. The elongated holes may be located at an upper portion (/upper end) of the device carrier (top is opposite to the first direction). Accordingly, the first plane may be the uppermost plane of the device carrier. The elongated holes may extend in the first plane.

The counterpart may be two (or equal to the number of screws of the fastening means) screw nuts, or a plate with two (or a corresponding number of) threads for receiving the screws or the like. Alternatively, the counterpart may also be something else that receives the front ends of the screws. The counterpart may fix the screws in such a way that the screws connect the fastening means to the device carrier. When the screws are tightened in the counterpart, the device carrier may be fixed to the fastening means in such a way that no displacement is possible any more. The counterpart may be one-piece, two-piece or multi-piece.

Furthermore, the fastening means may comprise a cardanic suspension.

The cardanic suspension may be a ball joint or another cardanic. The cardanic suspension is preferably located (in the mounted state) above the apparatus to be held with the device carrier. Due to the cardanic suspension, the center of gravity of the apparatus to be held (with device carrier and other parts) may be vertically perpendicular under the cardanic suspension. In combination with the (previously described) displacement using the elongated holes, the cardanic suspension may enable various angles of the apparatus to be held.

Furthermore, the two screws and the counterpart may be positioned in the first direction relative to the cardanic suspension.

Because the attachment is positioned below (in the first direction) the cardanic suspension, the center of gravity of the apparatus to be held with the attachment (in short: what is attached to the cardanic suspension) may hold the angle of the element to be held more stably. The center of gravity hangs lower and is therefore more stable.

Furthermore, the apparatus may be attachable to the device carrier in the first direction (/below) relative to the fastening means at least indirectly.

Also this may help to ensure a stable angle setting.

The apparatus (to be held) may be fastened directly or indirectly to the device carrier. Direct fastening may be by means of screws, clamps or the like. Alternatively, the device carrier may have a support surface on which the apparatus to be held may stand, possibly without any further fastening means. Indirect fastening may be achieved by means of a further device carrier and/or further intermediate elements.

Furthermore, the at least one counterpart may be two screw nuts, or the at least one counterpart may be a counterpart with two holes.

The two holes in the counterpart may (each) have a thread.

Furthermore, the device carrier may be displaceable relative to the fastening means in order to displace the center of gravity of the device carrier loaded with the apparatus at a predetermined inclination of the device carrier at least approximately below a suspension point on which the carrier is suspended by means of the fastening means.

The displacement may take place along the (two) elongated holes.

Furthermore, the elongated holes may be straight.

Straight elongated holes enable displacement in a straight line. Preferably, the different elongated holes are of the same length and extend in the same shape in the same direction. Preferably, a distance (are distances; distance between equal points of the elongated holes) between the elongated holes is equal to a distance (distances) between holes in the fastening means. This means that the screws in the corresponding elongated holes may utilize the full dimensions of the elongated holes when the device carrier is displaced relative to the fastening means.

Alternatively, the elongated holes may be curved and/or have corners (preferably all elongated holes have the same shape). This allows a displacement in other directions.

Preferably, the elongated holes extend forwards (and backwards) to enable a forward/backward inclination.

Furthermore, the device carrier may have a curved shape, in particular a C-curve shape.

This allows the device carrier to be guided around the apparatuses so that the space provided for the apparatuses may be optimally utilized. In addition, the connecting portion of the device carrier is thus provided in a simple manner, namely by the upper, at least partially horizontally extending curve of the C-curve of the device carrier. The center of gravity of the apparatus to be held is thus also located more centrally under the fastening means.

Furthermore, the fastening means may comprise four screws, and the device carrier may comprise four elongated holes (in the first plane).

Any number of screws and elongated holes greater than two is possible. It is also possible to guide two (or more) screws through one (larger) elongated hole (each). In the case of three or more elongated holes, these may be distributed in two dimensions on the first plane (i.e. not in a row next to each other). This may increase stability.

The present disclosure further comprises a method of manufacturing a carrier, the method comprising: providing a fastening means with two screws; providing a device carrier positioned in a first direction relative to the fastening means, wherein the apparatus is at least indirectly attachable to the device carrier, wherein the device carrier comprises two elongated holes in a (first) plane, wherein the (first) plane extends perpendicular to the first direction, and wherein the two elongated holes are aligned in a same direction; providing at least one counterpart, wherein the two screws are adapted to connect the fastening means to the at least one counterpart through the two elongated holes; and screwing the two screws into the counterpart, wherein the screws extend through the elongated holes.

The advantages described are neither limiting nor exclusive to the corresponding aspects. An aspect may have other advantages that are not explicitly mentioned.

The exemplary embodiments and examples disclosed herein are intended to provide features that are readily apparent by reference to the following description in conjunction with the accompanying Figures. In accordance with various embodiments, exemplary systems, methods and devices are disclosed herein. It will be understood, however, that these embodiments are presented as examples and not as limitations, and it will be apparent to those of ordinary skill in the art who have read the present disclosure that various modifications may be made to the disclosed embodiments while remaining within the scope of the present disclosure.

Therefore, the present disclosure is not limited to the exemplary embodiments and applications described and illustrated herein. Furthermore, the specific sequence and/or hierarchy of the steps in the methods disclosed herein are merely exemplary approaches. Based on design preferences, the specific order or hierarchy of steps of the disclosed methods or processes may be rearranged while remaining within the scope of the present disclosure. Accordingly, those skilled in the art will understand that the methods and techniques disclosed herein represent various steps or acts in an example order, and the present disclosure is not limited to the specific order or hierarchy unless otherwise expressly stated.

It is also understood that any reference to an element here with a designation such as “first”, “second” etc. does not generally limit the set or order of these elements. Rather, these designations may be used here as a practical means of distinguishing between two or more elements or instances of an element. The reference to a first and a second element therefore does not mean that only two elements may be used or that the first element must precede the second element in some way.

Various modifications of the implementations described in this disclosure are readily apparent to those skilled in the art, and the general principles defined herein may be applied to other implementations without departing from the scope of this disclosure. Therefore, the disclosure is not limited to the implementations shown herein but has the broadest possible scope consistent with the novel features and principles disclosed herein as set forth in the claims below.

The above and other aspects and their implementations are described in more detail in the drawings, the description and the claims.

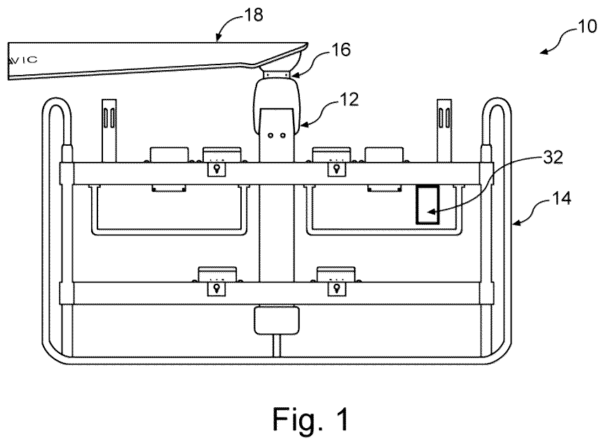

FIG. 1 shows an illustration of a carrier of an embodiment of the present disclosure.

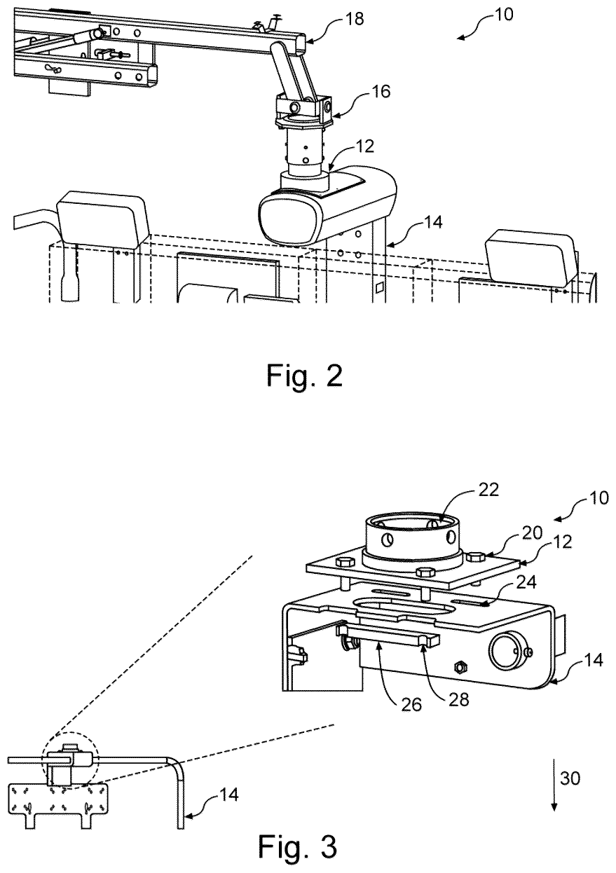

FIG. 2 shows an illustration of a carrier of an embodiment of the present disclosure.

FIG. 3 shows an illustration of a section of a carrier of an embodiment of the present disclosure.

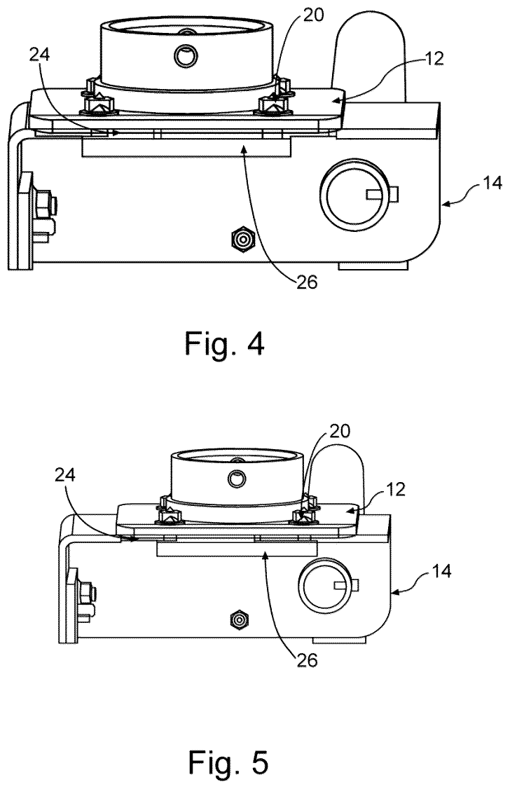

FIG. 4 shows an illustration of a carrier of an embodiment of the present disclosure in a displacement position.

FIG. 5 shows an illustration of the carrier of FIG. 4 in a second displacement position according to an embodiment of the present disclosure.

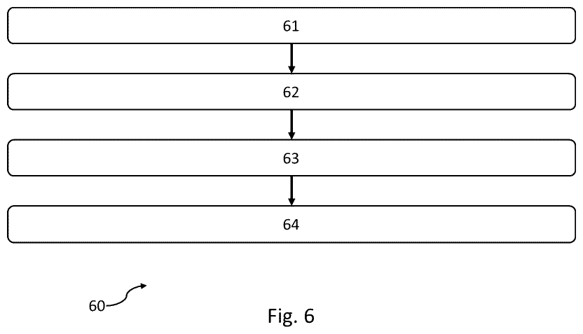

FIG. 6 shows a schematic flow chart of the manufacturing process of an embodiment of the present disclosure.

FIG. 1 shows an illustration of an exemplary carrier 10 according to an embodiment of the present disclosure. The carrier 10 comprises a fastening means 12, a device carrier 14, a cardanic suspension 16, a support arm 18 and a displaceable weight 32. The support arm 18 may be fixed to a wall or ceiling (by means of a fastening anchor). The device carrier 14 is attached to the cardanic suspension 16 by means of the fastening means 12. The fastening means 12 is connected to the support arm 18 by means of the cardanic suspension 16. The weight 32 may be displaced laterally (to the left and right in FIG. 1). In this way, the device carrier 14 may be tilted laterally relative to the support arm 18 by changing the center of gravity via the cardanic suspension 16. The displacement via elongated holes 24 may generate a tilting to the front and rear (in the perspective of FIG. 1)—depending on the extension of the elongated holes (preferably extended to the front and rear—i.e. out of the image plane).

FIG. 2 shows an illustration of an exemplary carrier 10 according to an embodiment of the present disclosure. The carrier 10 of FIG. 2 may be the same carrier 10 as in FIG. 1. In this case, FIG. 2 shows a section of FIG. 1. FIG. 2 shows the same (or similar) elements as FIG. 1. In order to avoid repetitions, some of the same features are not repeated. Reference is made to the above-mentioned disclosure. This also applies to the following Figures.

FIG. 3 shows an illustration of a section of an exemplary carrier 10 according to an embodiment of the present disclosure. The carrier 10 of FIG. 3 may be the same carrier 10 as in FIG. 1 and/or FIG. 2. While the upper right part of FIG. 3 shows the section, the lower left part shows which section of the carrier 10 is shown.

The carrier 10 comprises a fastening means 12 with four screws 20 and an attachment 22 for a cardanic suspension 16, a device carrier 14 with elongated holes 24, and a counterpart 26 with holes 28.

The fastening means 12 has an attachment 22 at the top (opposite the first direction 30) for the cardanic suspension 16. The cardanic suspension 16 may directly comprise the attachment 22 (for example as a ball joint). Alternatively, the cardanic suspension 16 may be connected to the attachment 22. Furthermore, the fastening means 12 comprises (in this case four) holes through which the (in this case four) screws 20 extend.

The device carrier 14 comprises (in this case four) elongated holes 24. The elongated holes 24 lie in the same (first) plane. The elongated holes 24 have the same orientation and dimensions. Furthermore, the elongated holes 24 have the same spacing from each other as the holes in the fastening means 12. This allows the screws 20 (which already extend through the holes in the fastening means 12) to also extend through the elongated holes 24 and move along the entire dimensions in the respective elongated hole 24 (even if all screws are threaded). The elongated holes 24 are straight.

The counterpart 26 comprises holes 28. The holes 28 have threads into which the screws 20 may be screwed. In FIG. 3, only one counterpart 26 is shown, namely for (only) two of the screws 20. There may be a further counterpart 26 for the other two screws 20. The counterparts 26 are positioned on the side of the (first) plane of the device carrier 14 facing away from the fastening means 12. The screws 20 may be screwed into the holes 28 of the counterparts and (if the screws 20 also extend through the holes of the fastening means 12 and the elongated holes 24) connect the device carrier 14 movably to the fastening means 12. When the screws 20 are tightened, the mobility may be prevented. When the fastening means 12 is moved relative to the device carrier 14, the counterparts 26 do not move relative to the fastening means 12. The counterparts 26 may also be formed in one piece, i.e. only one counterpart 26 may be provided for all screws 20.

FIGS. 4 and 5 show illustrations of an exemplary carrier 10 in various displacement positions according to an embodiment of the present disclosure. The carrier 10 of FIGS. 4 and 5 may be the same carrier 10 as in one or more of the preceding Figures.

In FIG. 4, the fastening means 12 with the counterpart 26 is displaced completely to the front (left in the Figure) relative to the device carrier 14. In FIG. 5, the fastening means 12 with the counterpart 26 is displaced completely to the rear (right in the Figure) relative to the device carrier 14. In both cases, the screws 20 hit one end of the elongated holes 24. Extreme positions are thus achieved. Intermediate positions are also possible-i.e. that the screws are located between the ends of the corresponding elongated holes 24.

FIG. 6 shows a schematic flowchart of the manufacturing method according to an embodiment of the present disclosure. The method 60 comprises steps 61 to 64. In step 61, a fastening means 12 with two screws 20 is provided. In step 62, a device carrier 14 positioned in a first direction 30 (/below) relative to the fastening means 12 is provided, wherein the apparatus is at least indirectly attachable to the device carrier 14, wherein the device carrier 14 comprises two elongated holes 24 in a (first) plane, wherein the (first) plane extends perpendicular to the first direction 30, and wherein the two elongated holes 24 are aligned in a same direction. In step 63, at least one counterpart 26 is provided, wherein the two screws 20 are adapted to connect the fastening means 12 to the at least one counterpart 26 through the two elongated holes 24. In step 64, the two screws 20 are screwed into the counterpart 26, wherein the screws 20 extend through the elongated holes 24.

1. A carrier for carrying an apparatus, the carrier comprising:
a fastening means with two screws;
a device carrier which is positioned in a first direction relative to the fastening means, wherein the apparatus is at least indirectly attachable to the device carrier, wherein the device carrier comprises two elongated holes in a plane, wherein the plane extends perpendicular to the first direction, and wherein the two elongated holes are aligned in a same direction;
at least one counterpart, wherein the two screws are adapted to connect the fastening means to the at least one counterpart through the two elongated holes.

2. The carrier according to claim 1, wherein the fastening means comprises a cardanic suspension.

3. The carrier according to claim 1, wherein the two screws and the counterpart are positioned in the first direction relative to the cardanic suspension.

4. The carrier according to claim 1, wherein the apparatus is at least indirectly attachable to the device carrier in the first direction relative to the fastening means.

5. The carrier according to claim 1, wherein the at least one counterpart is two screw nuts or wherein the at least one counterpart is one counterpart with two holes.

6. The carrier according to claim 1, wherein the device carrier is displaceable relative to the fastening means in order to displace the center of gravity of the device carrier loaded with the apparatus at a predetermined inclination of the device carrier at least approximately below a suspension point on which the carrier is suspended by means of the fastening means.

7. The carrier according to claim 1, wherein the elongated holes are straight.

8. The carrier according to claim 1, wherein the device carrier has a curved shape.

9. The carrier according to claim 1, wherein the fastening means comprises four screws and the device carrier comprises four elongated holes.

10. A method of manufacturing a carrier, the method comprising:
providing a fastening means with two screws;
providing a device carrier which is positioned in a first direction relative to the fastening means, wherein the apparatus is at least indirectly attachable to the device carrier, wherein the device carrier comprises two elongated holes in a plane, wherein the plane extends perpendicular to the first direction, and wherein the two elongated holes are aligned in a same direction;
providing at least one counterpart, wherein the two screws are adapted to connect the fastening means to the at least one counterpart through the two elongated holes; and
screwing the two screws into the counterpart, wherein the screws extend through the elongated holes.

11. The carrier according to claim 8, wherein device carrier has a C curved shape.
